(19) United States
(12) Patent Application Publication
(10) Pub. No.: US 2023/0137372 A1
(43) Pub. Date: May 4, 2023

(54) FRUIT PROCESSING DEVICE

(71) Applicant: John Bean Technologies Corporation, Chicago, IL (US)

(72) Inventors: Ronald D. Johnson, Lakeland, FL (US); Philip G. Hebbler, Winter Haven, FL (US); Brandon R. Coles, Temple Terrace, FL (US)

(73) Assignee: John Bean Technologies Corporation, Chicago, IL (US)

(21) Appl. No.: 18/049,842

(22) Filed: Oct. 26, 2022

Related U.S. Application Data
(60) Provisional application No. 63/263,259, filed on Oct. 29, 2021.

(51) Int. Cl. A23N 7/08

(52) U.S. Cl. CPC A23N 7/08

(57) ABSTRACT

A fruit processing apparatus 8 includes a chute 10 through which fruit 12 travel form a supply source and into one of a series of holding cups 14 positioned around the perimeter of a first rotating indexing delivery carousel 16. A second rotating indexing delivery carousel 18 is located side by side the first delivery carousel 16 and also includes a series of cups 14 positioned around its perimeter. Two corresponding holding cups 14 from the rotating delivery carousels 16 and 18 close towards each other to cooperatively form a cavity to retain the fruit 10 therein. A small separation remains between the two cups 14 through which passes a splitting device 20 for splitting the fruit in two sections or halves 12A, with one section/half remaining within each of the two cups 14. A pitter 24 in the form of a plunger projects forwardly through the fruit husk and against the fruit pit to eject the pit from the fruit. A rotating indexing removal carousel 30 is positioned adjacent each of the delivery carousels 16 and 18. A series of radially outwardly projecting removal screens 32 are positioned around the perimeters of the removal carousels 30. The removal screens 32 are configured to press into the fruit halves 12A disposed in the holding cups 14 to force the fruit pulp out through the screen openings 34, thereby to extract the fruit pulp from the husk 36 in the form of cubes 38 or other desirable shapes.

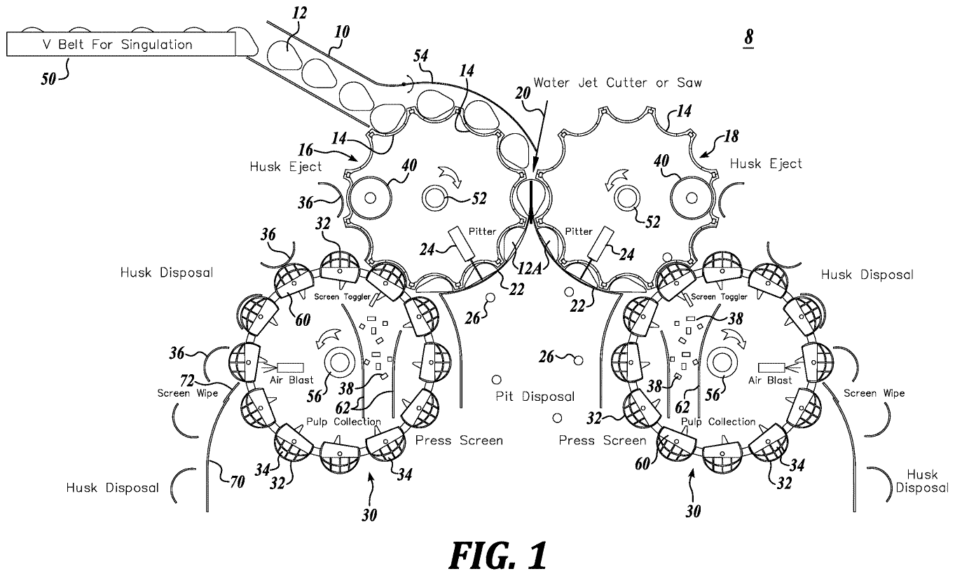

### CROSS-REFERENCE TO RELATED APPLICATION

This application claims the benefit of U.S. Provisional Application No. 63/263259, filed Oct. 29, 2021, the entire contents of which are expressly incorporated herein by reference.

### BACKGROUND

Currently, avocados and other “soft” fruit are processed manually where the corresponding pulp is required to remain intact. Not only is this a time-consuming, labor-intensive process, but it is also becoming difficult to attract workers who desire to perform this type of manual, repetitive work. Drum or roller squeeze systems currently exist that are capable of processing the avocado pulp into a paste or puree product. This processing method is not suitable where retaining chunks or solids content is required. For the US guacamole market, 30% solids or greater content is required by customers; for Asian markets, 50% or greater solids content is required. Avocado peelers exist for peeling the husk of the fruit, but do not split, pit, or dice or cut the fruit. These machines are semiautomatic and too slow to be cost effective for large-scale fruit processors.

Thus, there is an immediate industry need for an automated system and method of splitting and pitting the fruit and then removing the pulp from the husk in solid form. Moreover, it is desirable that the processing system be able to accommodate various size fruit with various pit sizes, without having to change machine components while processing the fruit, with minimal damage to the pulp, and with minimal pulp loss. The system and method of the present disclosure seek to achieve these results.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, an apparatus for processing fruit is provided. The apparatus includes flexible holding cups shaped for receiving a fruit; a splitting device to split the fruit while held by the holding cups, a plunger for ejecting the pit from the split fruit, a fruit pulp removal screen pressable into the holding cups to extract the fruit pulp from the fruit husk, and a collector to collect the fruit pulp extracted from the fruit husk by the removal screen.

In any of the embodiments described herein, wherein the holding cups are shaped to resemble the shape of the fruit being processed.

In any of the embodiments described herein, wherein the holding cups are of flexible construction to adapt to the shape and size of the fruit being processed.

In any of the embodiments described herein, wherein the holding cups are in the form of two halves that close towards each other to retain the fruit when being split by the splitting device.

In any of the embodiments described herein, wherein each holding cup retains half of the fruit after being split.

In any of the embodiments described herein, wherein a cover extends over the holding cups to retain a fruit half in the holding cup while the plunger operates to remove the pit from the fruit.

In any of the embodiments described herein, wherein the holding cups are located along the outer perimeter of a pair of delivery carousels that are disposed relative to each other to cause a holding cup from each delivery carousel to together hold the fruit being processed while maintaining a separation between the holding cups for passage of the splitting device during splitting of the fruit.

In any of the embodiments described herein, wherein the holding cups are formed in the perimeters of the delivery carousels.

In any of the embodiments described herein, wherein the fruit splitter is selected from the group consisting of a water jet, a saw, a knife.

In any of the embodiments described herein, wherein the plunger is positioned to extend through the holding cups and is in alignment with the pit of the fruit.

In any of the embodiments described herein, wherein the removal screen is formed in a convex exterior shape to engage into the holding cups and cause the fruit pulp to pass through the screen openings.

In any of the embodiments described herein, wherein the removal screen forces a fruit pit remaining in the holding cup out through the husk and out through the holding cup.

In any of the embodiments described herein, wherein the shape of the removal screen is selected from a shape selected from the group consisting of: the shape of the holding cup, the shape of the fruit, the shape of a prolate semi-spheroid, a semi-spherical shape.

In any of the embodiments described herein, wherein the removal screens are located along the outer perimeter of a removal carousel, the removal carousel rotating in synchronization with a corresponding delivery carousel to place a removal screen in registry with a holding cup.

In any of the embodiments described herein, further comprising a toggle assembly to toggle the removal screen within a holding cup to shear the fruit pulp from the husk.

In any of the embodiments described herein, wherein the removal screen is adapted to carry the fruit husk away from the holding cup.

In any of the embodiments described herein, further comprising a husk remover to remove the husk from the removal screen.

In any of the embodiments described herein, wherein the husk overlies the removal screen and the husk remover forces the husk off the removal screen by pressing against the portion of the husk overlying the removal screen.

In any of the embodiments described herein, wherein the husk remover is selected from the group consisting of a water jet, an air jet, a plunger.

In any of the embodiments described herein, further comprising a roller positioned to roll against the convex side of a holding cup to extract the husk from the holding cup if the husk remains within the holding cup after the fruit pulp is extracted from the husk.

A method is provided for processing fruit. The method includes placing a fruit in two adjacent holding cups shaped for together receiving the fruit, splitting the fruit while held by the holding cups, ejecting the pit from the split fruit, pressing removal screens into the split fruit to remove the fruit pulp from the husk by forcing the fruit pulp through the screen openings, and collecting the fruit pulp extracted from the fruit husk.

In any of the embodiments described herein, wherein the removal screens are toggled relative to the holding cups to shear the fruit pulp from the fruit husk.

In any of the embodiments described herein, further comprising splitting the fruit with a device selected from the group consisting of a water jet, a saw, a knife.

In any of the embodiments described herein, further comprising using a plunger to push the pit from the split fruit.

In any of the embodiments described herein, further comprising pressing the removal screen into the holding cup so that the husk becomes attached to the removal screen.

In any of the embodiments described herein, further comprising removing the husk from the removal screen.

In any of the embodiments described herein, wherein the husk is removed from the removal screen by applying a water jet, an air jet, or a plunger against the husk.

In any of the embodiments described herein, further comprising removing a husk that remains in a holding cup by flexing the holding cup to dislodge the husk from the holding cup.

### DESCRIPTION OF THE DRAWING

The foregoing aspects and many of the attendant advantages of this invention will become more readily appreciated as the same become better understood by reference to the following detailed description, when taken in conjunction with the accompanying FIGURE, which schematically illustrates an exemplary fruit processing apparatus and method of the present disclosure.

### DETAILED DESCRIPTION

In the following description and in the accompanying drawing, corresponding systems, assemblies, apparatus, and units may be identified by the same part number, but with an alpha suffix. the descriptions of the parts/components of such systems assemblies, apparatus, and units that are the same or similar are not repeated so as to avoid redundancy in the present application.

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “horizontal,” “vertical,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions.

The present application may include modifiers such as the words “generally,” “approximately,” “about,” or “substantially.” These are meant to serve as modifiers to indicate that the “dimension,” “shape,” “temperature,” “time,” or other physical parameter in question need not be exact, but instead may vary as long as the function that is required to be performed can be carried out. For example, in the phrase “generally circular in shape,” the shape need not be exactly circular as long as the required function of the structure in question can be carried out.

A fruit processing apparatus 8 is disclosed in the FIGURE as including, in basic form, a chute 10 through which fruit 12 travel from a supply source and into one of a series of holding cups 14, or simply cups 14, positioned around the perimeter of a first rotating indexing delivery wheel or carousel 16. A second rotating indexing delivery wheel or carousel 18 is located side by side the first delivery carousel 16. The second delivery carousel 18 also includes a series of cups 14 positioned around its perimeter. Two corresponding cups 14 from the rotating delivery carousels 16 and 18 close towards each other to cooperatively form a cavity to retain the fruit 12 therein. However, a small separation remains between the two cups 14 through which passes a splitting device 20 for splitting the fruit in two sections or halves 12A, with one section/half remaining within each of the two cups 14. As the delivery carousels 16 and 18 continue to rotate, the two cups 14 separate from each other after the splitting of the fruit, whereupon covers 22 extend over the cups 14 to retain the fruit halves 12A therein.

A pitter 24 in the form of a plunger projects forwardly through the fruit husk 36 and against the fruit pit 26 to eject the pit from the fruit. A rotating indexing removal wheel or carousel 30 is positioned adjacent and in close proximity to each of the delivery carousels 16 and 18. A series of radially outwardly projecting removal screens 32 are positioned around the perimeters of the removal carousels 30. The removal screens 32 are configured to press into the fruit halves 12A disposed in the holding cups 14 to force the fruit pulp 38 out through the screen openings 34, thereby to extract the fruit pulp 38 from the husk 36 in the form of cubes or other desirable shapes.

If, after the extraction of the fruit pulp 38, the husk 36 remains in the cup 14, a roller 40 presses against the convex surface of the cup to eject the husk 36 from the cup. If, on the other hand, the husk 36 is transferred to a removal screen 32, the husk is ejected from the removal screen by an air blast or other means.

Next describing the fruit processing apparatus 8 in more detail, fruit 12 is delivered to the chute 10 in single file from a V belt conveyor 50 or other delivery mechanism wherein the fruit has been or is singulated so as to enter the chute one at a time. This enables each fruit 12 to be loaded on to a cup 14 by gravity as the cup is rotating near the top of the carousel 16. Although not essential, the cups 14 may be shaped to generally correspond to the shape of the fruit. For example, if the fruit is oblong in shape, the cups may also be oblong in shape in the direction of the circumference of the delivery carousels 16 and 18. However, if the fruit is substantially spherical in shape, then the cups 14 may be generally semi-spherical in shape.

In addition, the cups 14 may be composed of a flexible, but durable, material so as to conform or adapt to the size and exterior shape of the fruit 12. The cups 14 may be mounted to the outer perimeter of the delivery carousels 16 and 18. In this regard, the cups are attached in place so as to provide clearance behind the cups to enable the cups to conform to the shape of the fruit 12. Alternatively, the cups may be integrally constructed as part of the delivery carousels 16 and 18. In this alternative configuration, clearance is provided behind the base of the cups to allow the cups to flex or otherwise conform to the shape of the fruit 12.

The delivery carousels 16 and 18 are depicted as having twelve cups 14 each. However, the number of cups associated with each of the delivery carousels 16 and 18 may be fewer in number or greater in number depending on various factors, for example, the size of the fruit 12 being processed and the speed of operation of the processing system 8.

The delivery carousels 16 and 18 are rotated on axles 52, which are in turn powered by a drive system in a synchronized manner so that the cups 14 of the carousels align with each other when the cups come together, as discussed below.

As the fruit 12 travels from the top of carousel 16 and downwardly towards carousel 18, the fruit is held within the cups 14 of carousel 16 by a cover 54 extending from the end of the chute 10. As shown in the FIGURE, the cover 54 is curved to correspond to the curved perimeter defined by the fruit being carried in the cups 14. The cover 54 terminates at a location just short of the delivery carousel 18, whereupon the fruit 12 is captured by the cups 14 of both delivery carousels 16 and 18.

As noted above, when the two corresponding cups 14 are positioned at their closest locations relative to each other, they cooperatively form a cavity for retaining and holding the fruit 12 therein. However, the holding cups 14 of the delivery carousels 16 and 18 do not actually touch each other, but rather a small gap or slot exists there between. The splitting device 20 passes through the gap between the cups 14 to split the fruit 12 into two sections or halves 12A.

The splitting device 20 can take various forms. For example, the splitting device can be in the form of a high-speed water jet that passes through the gap. As further examples, the splitting device can be in the form of a saw or a knife. If a knife, it can be in the form of a rotating blade that is capable of quickly passing through the gap.

Curved covers 22 extend along the perimeter of delivery carousels 16 and 18 from the splitting gap to a location close to the perimeter of the removal carousels 30 to retain the fruit sections 12A in corresponding cups 14. The covers 22 can continue to extend along a portion of the removal carousels 30 as shown in the FIGURE. The covers 22 need not be of solid construction, but can be in the form of, for example, spaced apart rails so that the fruit pits 26 can pass through the covers (between the rails) when ejected by the pitter 24.

The pitter 24 is illustrated as being in the form of a plunger extending through the holding cup 14 and the husk 36 to impact against the fruit pit 26, causing the pit to be ejected through the cover 22 to fall downwardly into a disposal location. A collection bin or other receptacle system can be used to collect the pits 26 for disposal or for use, such as compost. The pitter 24 can take forms other than as illustrated. Also, a slot or other configuration of opening can be formed in the cup to allow clearance for the plunger when extended to eject the pit 26.

The removal carousels 30 rotate on axles 56 in synchronization with the delivery carousels 16 and 18 so that removal screens 32 coincide with the locations of the cups 14. As such, a removal screen 32 engages into a holding cup 14 as the delivery carousel 16 and 18 and the removal carousels 30 continuously rotate. The axles 56 may be driven by the same drive system used to drive axles 52.

The removal screens 32 can be of various shapes or configurations. As one example, as shown in the FIGURE, the removal screen 32 is generally semi spherical in shape so as to generally match the shape of the holding cup 14. If the cup 14 is of a different shape, such as in the form of a prolate semi-spheroid, then the removal screen can be correspondingly shaped. The screen will be made of stainless steel or other hygienic material (round, flat or geometrical). The openings in the screen can be of various sizes and geometric shape, depending on the intended use of the pulp.

The removal screen 32 is mounted on an open swivel base 60 to support the removal screen as the screen enters into the fruit husk 36, thereby pressing through the fruit pulp. This action of the removal screen causes the fruit pulp to pass though the screen openings and fall downwardly through the open base 60 and into a pulp collection area. In this regard, the base 60 is toggled relative to the husk 36 to shear the pulp from the husk. The toggling can be accomplished via a cam system operating between the base 60 and the carousel 30, by an actuator acting on the base 60, or by another system. Partitions 62 can be positioned below the open base 60 to direct the removed fruit pulp 38 to the collection area.

Through this process, the fruit pulp 38 is divided into shapes having a cross-section corresponding to the shape of the openings in the removal screen. For example, if the screen openings are square in shape, the fruit pulp 38 will be square in cross-section. As such, the fruit pulp 38 when removed from the husk will be divided generally into cubes or cube-like shapes. On the other hand, if the screen openings are triangular in shape, the fruit pulp is divided into shapes having a triangular cross section.

The machine can also be adapted with different screens to produce fruit slices, halves, or full or depth-controlled segments. For example, if larger fruit is being processed, the removal screen system could be designed to penetrate part way into the husk and then the screen toggled so that cube-shaped pieces (or other shapes) of the pulp are formed, and then penetrating to the husk to cut a second set of cube-shaped pieces from the pulp.

If the pitter 24 fails to remove the fruit pit 26 from the fruit half 12A, the removal screen 32 presses the pit through the husk 36 and then out through the holding cup 14 for disposal.

Once the fruit pulp has been separated, the husk 36 is removed from the holding cup 14. In this regard, if the husk 36 remains in the holding cup 14, a roller 40 is used to roll against the convex side of the holding cup to sufficiently flex or otherwise deform the holding cup as shown in the FIGURE, which causes the husk to detach from the cup. The detached husk 36 is directed to a husk collection area for disposal. In this regard, a partition 70 can be used to help direct the detached husk 36 to the collection area.

If the husk 36 does not remain within the cup 14, but instead is transferred to the removal screen 32, the husk can be removed from the removal screen, for instance, by directing a blast of air through the open base 60 of the removal screen, thereby to detach the husk from the removal screen, causing the husk to fall downwardly into the collection area. Again, in this regard, the partition 70 can be used to direct the detached husk to the collection area.

After removal of the husk 36 from the removal screen 32, the screen is cleaned before it again functions to remove the fruit pulp 38 from the fruit sections 12A. In this regard, a wiper 72 can be used to wipe the pulp from the exterior of the screen. Also, pressurized air or water can be directed to and through the removal screen to remove any fruit pulp that may have lodged on the screen. Thereafter, the removal screen 30 continues along a rotational path to encounter a removal cup 14 to repeat the process of harvesting the fruit pulp 38.

While illustrative embodiments have been illustrated and described, it will be appreciated that various changes can be made therein without departing from the spirit and scope of the invention.

For example, although one set of delivery carousels 16 and 18, with corresponding removal carousels 30, are shown in the FIGURE, to increase production, one or more further sets of delivery carousels 16 and 18, along with corresponding removal carousels 30, can be located in adjacent relationship to the depicted carousels 16, 18, and 30. The one or more further sets can be driven by the same axles 52 and 56.

A desired production speed is to process at least two fruits (item 12) per second. It is possible that this production level can be met with one set of delivery carousels 16 and 18 and corresponding removal carousels 30. But, if need be, or if a higher production level is desired, as noted above additional sets of delivery and removal carousels can be used.

Also, the present apparatus and method can be used to process various types of fruits, including for example, avocados, kiwi, mango, melons and cantaloupe. Each of these types of fruits have a substantial husk. The present disclosure can be used with other types of fruits with or without substantial husks, such as papaya, or even with vegetables, such as squash or pumpkin. If the fruit/vegetable does not have a pit, but instead has seeds at its center, the pitter 24 can be replaced with a scraper or other tool to remove the seeds prior to collecting the fruit pulp.

In addition, the removal screen can be configured as a series of curved, parallel spaced-apart blades that cut the fruit pulp 38 into slices as the removal screen is pressed into the husk. The slices are removed from the husk as the blades are toggled relative to the husk in the manner described above. If the toggling occurs about a horizontal axis, the blades can be disposed in a vertical orientation, so that the slices are sheared from the husk during the toggling.

Further, the removal screen can be configured to cut the fruit pulp into halves, quarters, etc. as desired. The removal screen thus configured can be operated in the same manner as described above.

1. An apparatus for processing fruit, comprising:
a. flexible holding cups shaped for receiving a fruit;
b. a splitting device to split the fruit while held by the holding cups;
c. a plunger for ejecting the pit from the split fruit;
d. a fruit pulp removal screen pressable into the holding cups to extract the fruit pulp from the fruit husk; and
e. a collector to collect the fruit pulp extracted from the fruit husk by the removal screen.

2. The apparatus of claim 1, wherein the holding cups are shaped to resemble the shape of the fruit being processed.

3. The apparatus of claim 1, wherein the holding cups are of flexible construction to adapt to the shape and size of the fruit being processed.

4. The apparatus of claim 1, wherein the holding cups are in the form of two halves that close towards each other to retain the fruit when being split by the splitting device.

5. The apparatus of claim 4, wherein each holding cup retains half of the fruit after being split.

6. The apparatus of claim 4, wherein a cover extends over the holding cups to retain a fruit half in the holding cup while the plunger operates to remove the pit from the fruit.

7. The apparatus of claim 4, wherein the holding cups are located along the outer perimeter of a pair of delivery carousels that are disposed relative to each other to cause a holding cup from each delivery carousel to together hold the fruit being processed while maintaining a separation between the holding cups for passage of the splitting device during splitting of the fruit.

8. The apparatus of claim 7, wherein the holding cups are formed in the perimeters of the delivery carousels.

9. The apparatus of claim 1, wherein the fruit splitter is selected from the group consisting of a water jet, a saw, a knife.

10. The apparatus of claim 1, wherein the plunger is positioned to extend through the holding cups and is in alignment with the pit of the fruit.

11. The apparatus of claim 1, wherein the removal screen is formed in a convex exterior shape to engage into the holding cups and cause the fruit pulp to pass through the screen openings.

12. The apparatus of claim 11, wherein the removal screen forces a fruit pit remaining in the holding cup out through the husk and out through the holding cup.

13. The apparatus of claim 11, wherein the shape of the removal screen is selected from a shape selected from the group consisting of: the shape of the holding cup, the shape of the fruit, the shape of a prolate semi-spheroid, a semi-spherical shape.

14. The apparatus of claim 11, wherein the removal screens are located along the outer perimeter of a removal carousel, the removal carousel rotating in synchronization with a corresponding delivery carousel to place a removal screen in registry with a holding cup.

15. The apparatus of claim 11, further comprising a toggle assembly to toggle the removal screen within a holding cup to shear the fruit pulp from the husk.

16. The apparatus of claim 1, wherein the removal screen is adapted to carry the fruit husk away from the holding cup.

17. The apparatus of claim 16, further comprising a husk remover to remove the husk from the removal screen.

18. The apparatus of claim 17, wherein the husk overlies the removal screen and the husk remover forces the husk off the removal screen by pressing against the portion of the husk overlying the removal screen.

19. The apparatus of claim 1, further comprising a roller positioned to roll against the convex side of a holding cup to extract the husk from the holding cup if the husk remains within the holding cup after the fruit pulp is extracted from the husk.

20. A method for processing fruit, comprising:
a. placing a fruit in two adjacent holding cups shaped for together receiving the fruit;
b. splitting the fruit while held by the holding cups;
c. ejecting the pit from the split fruit;
d. pressing removal screens into the split fruit to remove the fruit pulp from the husk by forcing the fruit pulp through the screen openings; and
e. collecting the fruit pulp extracted from the fruit husk.
